(19) United States
(12) Patent Application Publication
(10) Pub. No.: US 2018/0317573 A1
(43) Pub. Date: Nov. 8, 2018

(54) Attachable and Detachable, Portable Electric Heating Device for Apparel and Methods of Use Thereof

(71) Applicant: Anthony W Devito, Tempe, AZ (US)

(72) Inventor: Anthony W Devito, Tempe, AZ (US)

(21) Appl. No.: 15/555,360

(22) PCT Filed: Mar. 2, 2016
(86) PCT No.: PCT/US2016/020354

§ 371 Date: Mar. 9, 2018

Related U.S. Application Data
(60) Provisional application No. 62/126,982, filed on Mar. 2, 2015.

(51) Int. Cl. A41D 13/005; H05B 3/34

(52) U.S. Cl. CPC A41D 13/0051; A41D 13/0058; H05B 2203/036; H05B 2203/005; H05B 3/342

(57) ABSTRACT

An electric heating device and method of use for heating apparel wherein the electric heating device has as plurality of integral pad-like constructions, each having a plurality of substantially planar fabric layers with a proximal surface and a distal surface with respect to the user. A plurality of electrically conductive wires are embedded in or attached to the interior or exterior surface of at least one of the plurality of substantially planar fabric layers. The plurality of integral pad-like constructions are connected in series or parallel by the insulated wire and the insulated wire is removably attachable to a compact, light weight power source such that the insulated wire conducts electricity to the electrically conductive wires when attached to the power source. When the electricity runs through the electrically conductive wires, it produces heat in at least one integral pad-like construction. The compact, lightweight power source is stored in or on the apparel.

### RELATED APPLICATIONS

This application claims priority to PCT Application No. PCTUS16/20354 filed Mar. 2, 2016. The entire contents of the above application are hereby incorporated by reference as though fully set forth herein.

### FIELD

The present invention relates to electric heating devices. More particularly, the present invention relates to a portable, attachable/detachable electric heating device for a garment or other article of apparel and method of use.

### BACKGROUND

Battery operated and electrically heated apparel such as coats, vests and coat liners are commercially available and known in the prior art. However, the heating elements are permanently attached or integrated with the apparel before purchase, thereby limiting the consumer to select their purchase from styles of apparel already fitted with the heating functionality. Additionally, consumers who have only an occasional need for heated apparel, such as a coat, are reluctant to buy an expensive heated coat that will not be used on a frequent basis. As such, there is a need to provide an attachable/detachable electric heater for apparel that can be fitted to a variety of apparel options, thereby allowing the consumer to use already purchased apparel for their apparel heating needs.

### BRIEF SUMMARY OF THE INVENTION

The present invention seeks to meet this need by utilizing known apparel heating technology that can be installed in or on the apparel on a temporary or permanent basis after the point of purchase. The heating elements and power source are attachable/detachable from the apparel rather than being permanently affixed to the apparel prior to purchase.

In one embodiment of the present invention, an electric heating device for heating apparel is disclosed comprising generally a plurality of integral pad-like constructions, each comprising a plurality of substantially planar fabric layers with a proximal surface and a distal surface with respect to the user. A plurality of electrically conductive wires is embedded in or attached to the interior or exterior surface of at least one of the plurality of substantially planar fabric layers. The plurality of integral pad-like constructions is connected in series or parallel by the insulated wire and the insulated wire is removably attachable to a compact, light weight power source such that the insulated wire conducts electricity to the electrically conductive wires when attached to the power source. When the electricity runs through the electrically conductive wires, it produces heat in at least one integral pad-like construction. The compact, lightweight power source is stored in or on the apparel.

In another embodiment of the present invention, a method for heating a piece of clothing apparel worn by a user wherein the heating device described above is removably attached to the apparel is disclosed.

### BRIEF DESCRIPTION OF THE DRAWINGS

FIG. 1A. Is a perspective view of one embodiment of the present invention wherein the insulated wires are wired in series.

FIG. 1B. Is a perspective view of one embodiment of the present invention wherein the insulated wires are wired in parallel.

FIG. 1C. Is a perspective view of one embodiment of the present invention showing additional integral pad-like constructions added to the heating device.

FIG. 2A. Is a front view of a coat showing an option for placement of the heating elements of the present invention.

FIG. 2B. Is a back view of a coat showing an option for placement of the heating elements of the present invention.

FIG. 2C. Is a back view of a coat showing an option for placement of the heating elements of the present invention.

FIG. 3. Is an exemplary view of the layers of fabric in the pad-like construction.

FIG. 4. Is an exploded view of the layers of fabric in the pad-like construction with the wires hidden by substantially planar fabric connectors.

FIG. 5. Is an exploded perspective view of the fabric pad layers of the present invention.

FIG. 6. Is an interior front view of a coat showing an option for placement of the heating elements of the present invention.

FIG. 7. Is a perspective view showing the integral pad-like constructions in a circumference around the user.

FIG. 8A. Is a front view of one embodiment of the shape of the heating device of the present invention.

FIG. 8B. Is a front view of an alternative embodiment of the shape of the heating device of the present invention.

FIG. 8C. Is a front view of an alternative embodiment of the shape of the heating device of the present invention.

FIG. 8D. Is a front view of an alternative embodiment of the shape of the heating device of the present invention.

FIG. 8E. Is a front view of an alternative embodiment of the shape of the heating device of the present invention.

FIG. 8F. Is a front view of an alternative embodiment of the shape of the heating device of the present invention.

### DETAILED DESCRIPTION

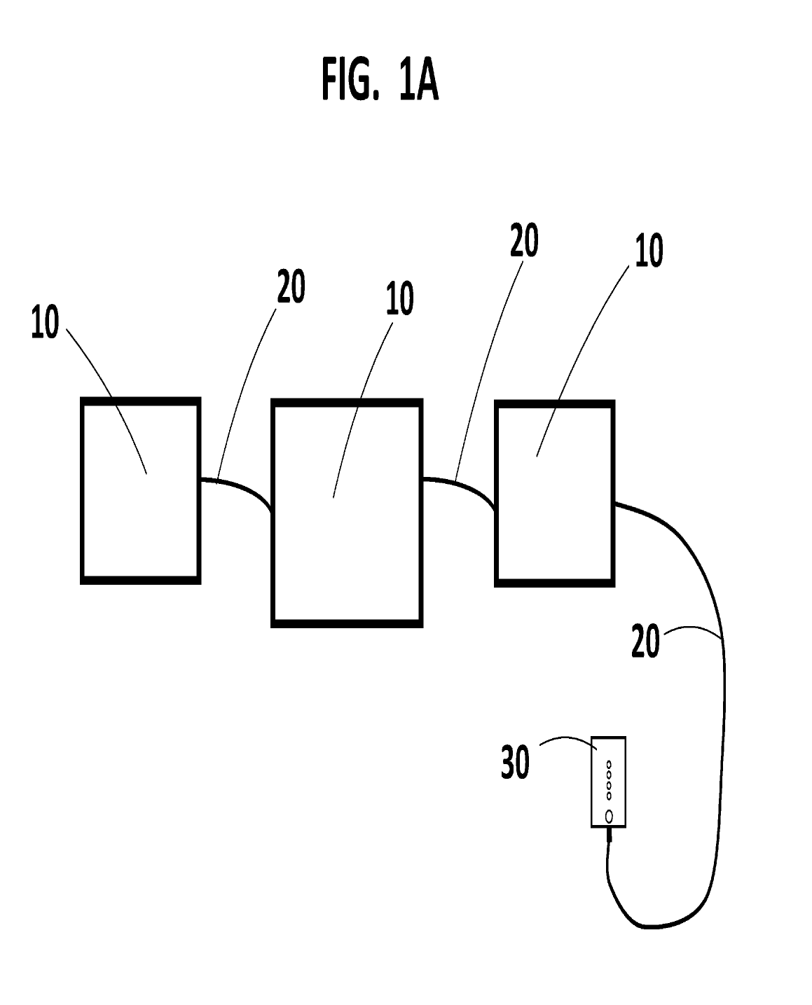

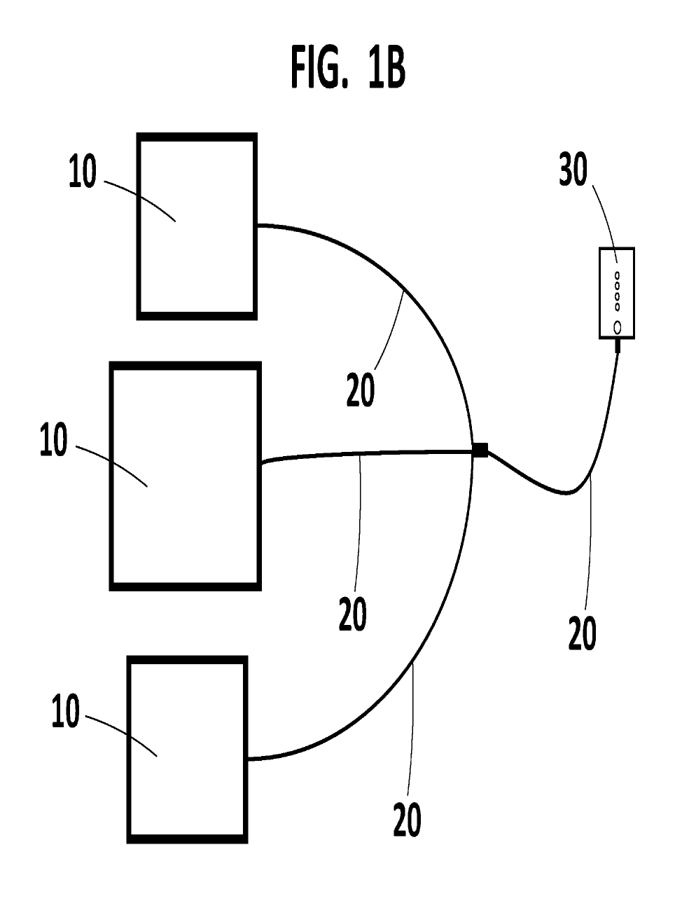

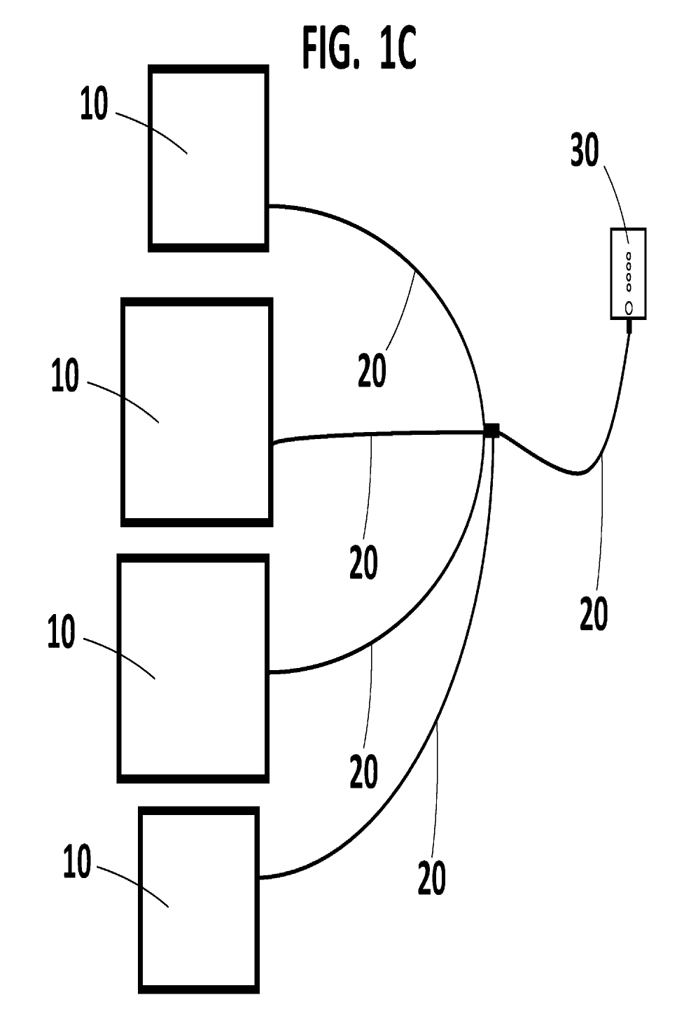

Turning to FIG. 1A, a heating device for heating a piece of clothing apparel worn by a user is shown with a plurality of integral pad-like constructions 10 connected by an insulated wire 20 in series to a compact, light weight power source 30.

Turning to FIG. 1B, a heating device for heating a piece of clothing apparel worn by a user is shown with a plurality of integral pad-like constructions 10 connected by an insulated wire 20 in parallel to a compact, light weight power source 30.

Turning to FIG. 1C, a heating device for heating a piece of clothing apparel worn by a user is shown with a plurality of integral pad-like constructions 10 connected by an insulated wire 20 with an additional integral pad-like construction easily added and connected by insulated wire to a compact, light weight power source 30.

The insulated wire 20 may be resistant to heat and cold, and also a constant fluctuation from hot to cold and vice versa. The insulated wire 20 may have a fabric covering, including but not limited to, an elastic based fabric. The insulated wire 20 is connected to the conductive wire using methods known in the prior art such as soldering.

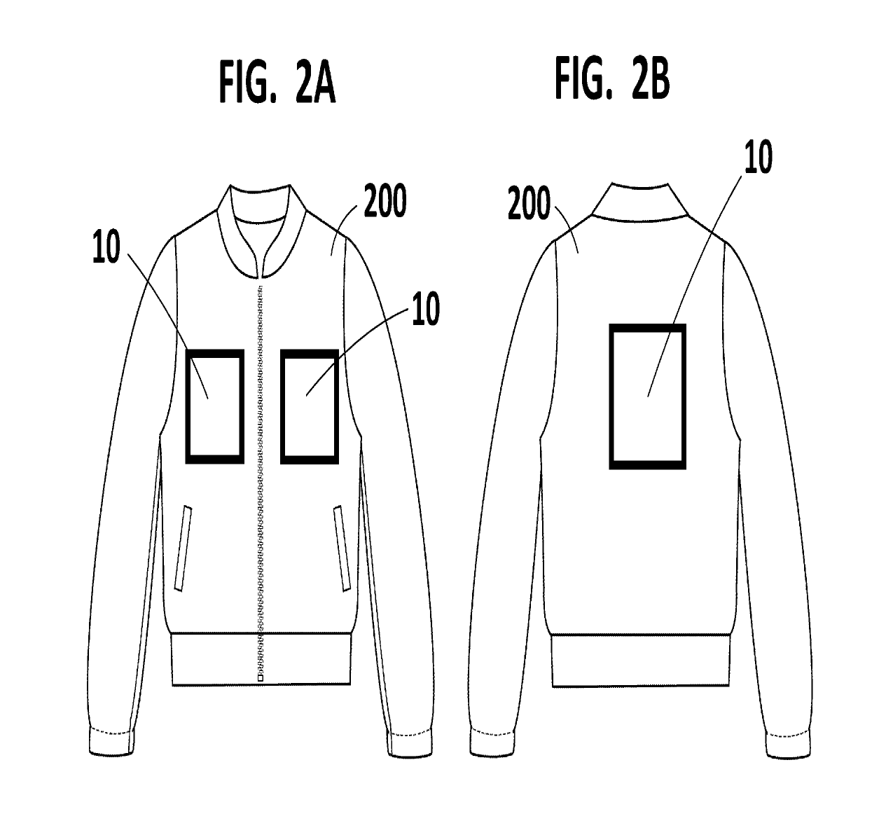

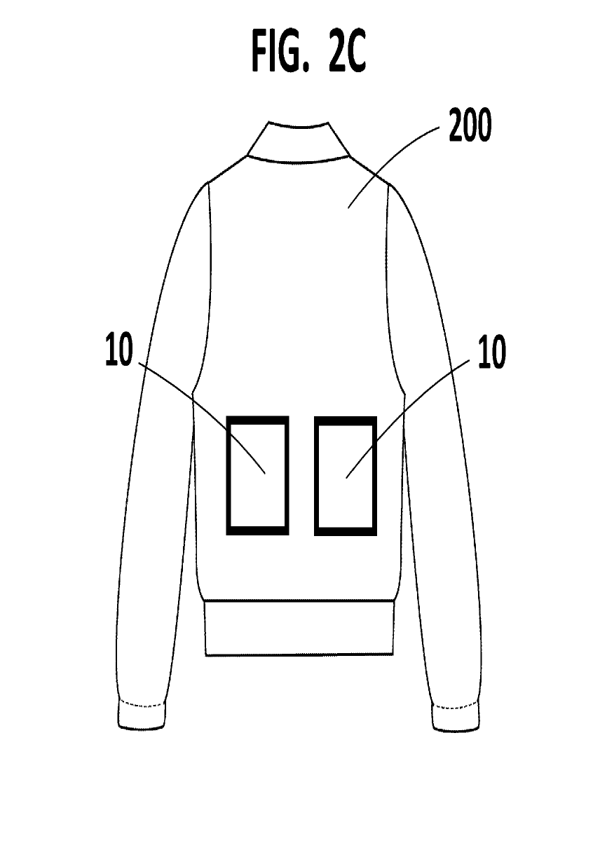

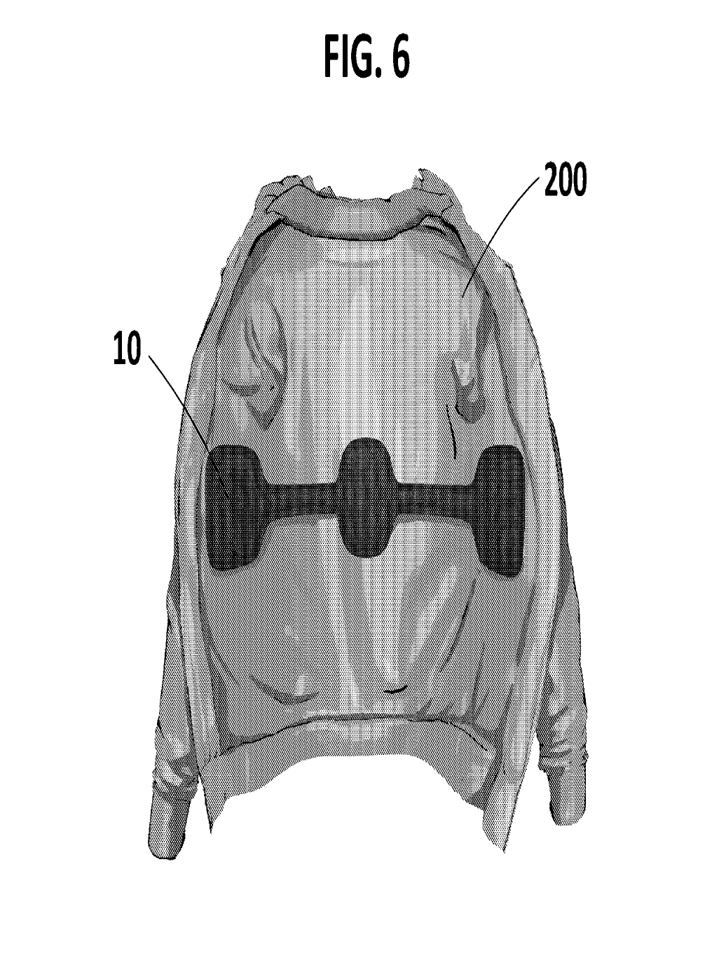

As shown in FIGS. 2A-2C and FIG. 6, the integral pad-like constructions 10 can be attached to apparel, such as a coat 200, in any desirable location. In the preferred embodiment, two integral pad-like constructions 10 are placed in the interior of the coat near the left and right breast with a second integral pad-like construction 10 placed between the shoulder blades. Alternatively, as shown in FIG. 2C, two integral pad-like constructions may be placed on the back side of the coat on the lower portion around the user's waist.

The power source 30 (shown in FIG. 1A-1C), such as a battery, can be placed in the inside pocket of the coat, or in an attachable/detachable pocket provided with the heating device. The provided pocket can be permanently fixed to one of integral pad-like constructions or can be attachable/detachable to one of the integral pad-like constructions. The pocket may be made of a thin, durable material, with a way to seal or close the pocket, including but not limited to (a) hook and loop fasteners; (b) barb and pile fasteners; (c) buttons; (d) snap fasteners; (e) hook and eye fasteners; (t) zippers; (g) pins; (h) buckle fasteners; (i) strap fasteners; G) slide fasteners; (k) glue; (l) polymer bases adhesive; (m) high tack adhesive; (n) quick setting adhesive or (o) combinations thereof.

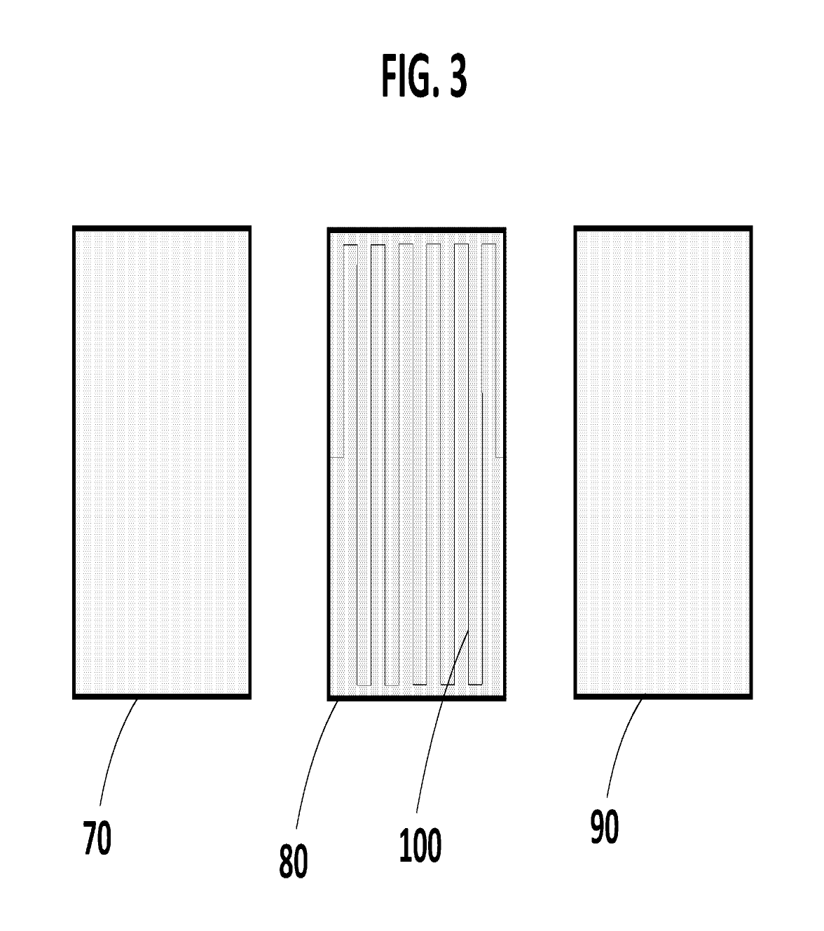

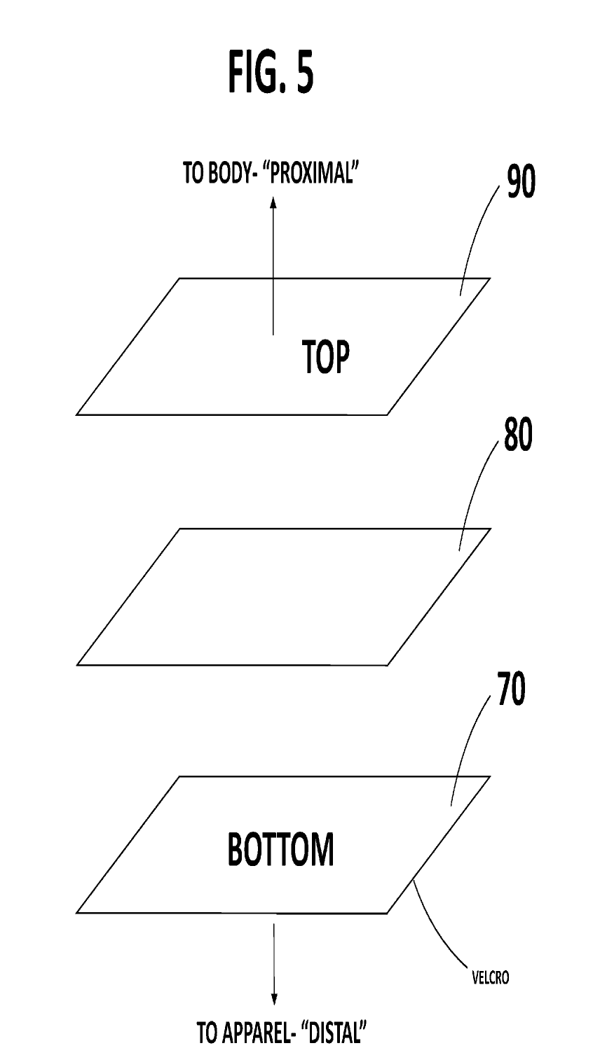

Turning to FIGS. 3-5, the integral pad-like constructions are constructed from a plurality of substantially planar fabric layers with a proximal surface and a distal surface with respect to the user. As shown in FIG. 5, the bottom surface of a first fabric layer 70 of the plurality of layers is removably attached to the apparel and the top surface of the first fabric layer is preferably a heat reflective material. The heat reflective material may be comprised of materials including, but not limited to, Mylar, foil, reflective heat tape or combinations thereof.

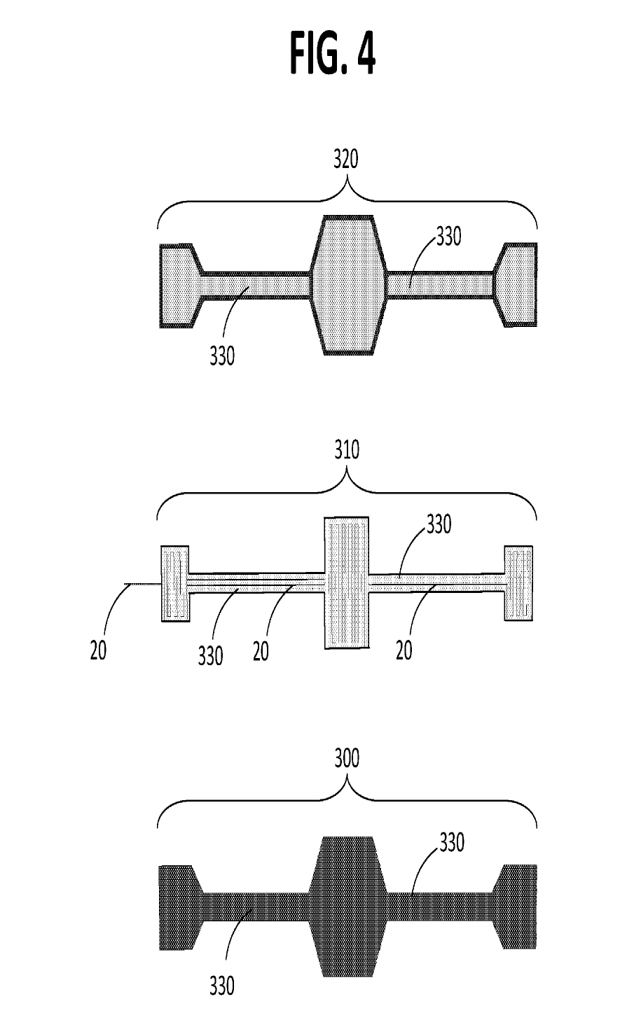

As shown in FIG. 5, a second fabric layer 80 of the plurality of layers that abuts the first fabric layer is constructed of a flexible, breathable material with a high flash point. As shown in FIG. 3-4, in the preferred embodiment, a plurality of electrically conductive wires 100 are embedded in or attached to the interior or exterior surface of this second fabric layer 80. The optimum fabric material for the fabric pads will cover the conductive wires 100, allow the maximum amount of heat to penetrate through, but will also be comfortable and appealing to the eye.

The insulated wire 20 is removably attachable to the power source 30 such that the insulated wire conducts electricity to the electrically conductive wires 100 when attached to the power source 30. The electricity runs through the electrically conductive wires 100 to produce heat in at least one integral pad-like construction.

As shown in FIG. 5, the top surface 90 of a third layer of the plurality of layers that abuts the second fabric layer may be lined with a heat conductive material. The heat conductive material is selected from the group including, but not limited to, polyester, cotton mesh, polymer fabric, flannel, fleece or combinations thereof. It is contemplated the layers of the integral pad-like construction are secured together by adhesive method or stitching methods that are well known in the prior art.

As shown in FIG. 4, another embodiment of the present invention essentially “hides” the insulated wire 20 by connecting each fully constructed heating element 10 with at least a plurality of fabric connectors 330. In this configuration, the fabric pad layers and the fabric connectors 330 are continuous pieces of fabric. The layers are constructed such that the top surface of the fabric pad layer 300 abuts the bottom surface of the second fabric pad layer 310 and wherein the top surface of the second fabric pad layer 310 abuts the bottom surface of the third fabric pad layer 320. The bottom surface of first fabric pad layer 300 is placed against the apparel distal to the user and the top surface of third fabric pad layer 320 faces away from the apparel proximal to the user. The bottom surface of the first fabric pad layer 300 that is distal to the user has a means for attaching, securing or adhering the heating element to the apparel.

In the preferred embodiment, the fabric connectors 330 are positioned between the heating elements 10 and do not have embedded conductive wire, although it is noted that they could contain embedded conductive wire. The insulated wire 20 may be encased between three layers of fabric 300, 310 and 320. This embodiment allows the product to be one seamless item without exposed insulated wire 20 that is installed in apparel, such as a coat. Additionally, the fabric connectors 330 may be comprised of an elastic material that serves as a means to adjust device slzmg.

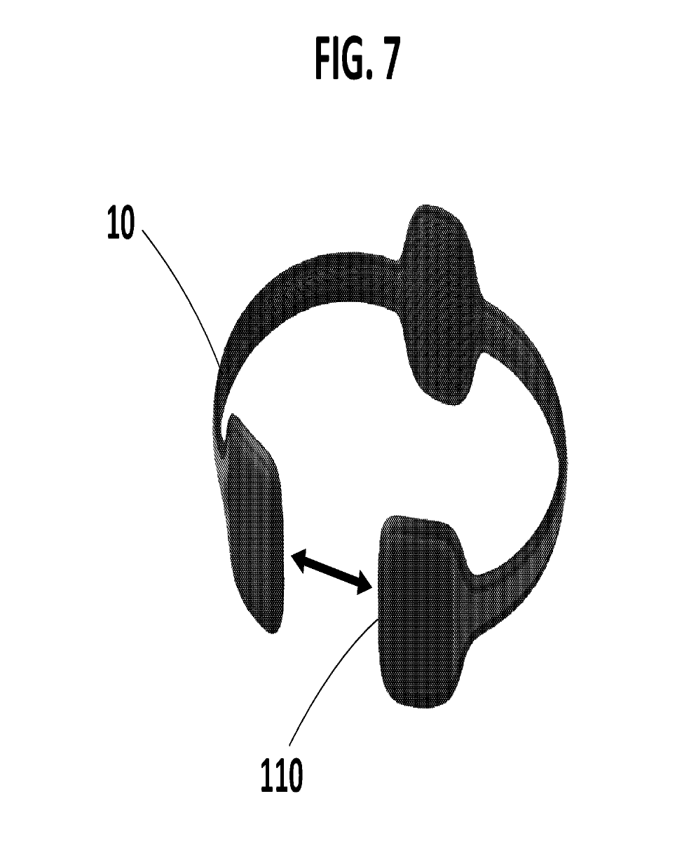

Turning to FIG. 7, the present invention may include a means to secure the integral pad-like constructions in a circumference around the user, such as a clasp 110 or other device capable of securing the pad-like constructions 10 to one another around the user.

In the preferred embodiment, the compact, light weight power source 30 is a lithium-ion or lithium polymer battery. In order to preserve long battery life and sufficient power to heat the pad-like constructions, the battery rating is preferably from about 2200 milliampere per hour to about 5000 milliampere per hour. The higher the mah rating, the longer the battery will last, but also the higher the mah rating will result in bigger, bulkier batteries. As such, higher mah rated batteries are preferred but only to the extent they are available in compact sizes and weights. The battery may control a plurality of heat settings. The compact, light weight power source may have variable settings to control the amount of heat produced in the integral pad-like constructions. The heating device may further comprise a device connected through a wireless connection wherein the device controls the variable settings on the compact, light weight power source. The wireless connection formed using technology such as Bluetooth or other wireless connection applications and the device including, but not limited to, a tablet, mobile phone, laptop computer or desktop computer.

In the preferred embodiment, the material of the electrically conductive wires 100 are selected from the group including, but not limited to, carbon fiber, stainless steel, steel alloys, far infrared ray (FIR) or any combination thereof.

In the preferred embodiment, the means for removably attaching the integral pad-like constructions 10 to the apparel includes, but is not limited to fasteners such as: (a) hook and loop fasteners; (b) barb and pile fasteners; (c) buttons; (d) snap fasteners; (e) hook and eye fasteners; (t) zippers; (g) pins; (h) buckle fasteners; (i) strap fasteners; G) slide fasteners; (k) glue; (l) polymer bases adhesive; (m) high tack adhesive; (n) quick setting adhesive or (o) combinations thereof. One end of the fastener is permanently or removably attached to the integral pad-like construction and the corresponding end of the fastener is permanently or removably attached to the apparel. The integral pad-like construction and fasteners can be of various shapes and sizes.

Hook and loop fasteners, such as Velcro®, come from the manufacturer with the adhesive already on the backside of the Velcro®, The consumer then peels off the paper that protects the adhesive, and sticks the Velcro® at the appropriate placement on the apparel. In the preferred embodiment, the Velcro® is semi-permanently affixed to the consumer's coat, as the adhesive is strong enough to withstand normal wear and tear yet also allows the repeated removal of the integral pad-like constructions from the Velcro® strip. The Velcro® loops can be pulled off the coat without damaging the consumer's coat, and without leaving a trace of residue from the adhesive. Other methods for attaching the heating elements on a more permanent basis to the apparel are contemplated herein, including but are not limited to, safety pins, clips, glue, iron on adhesives, sewing, pinning, hooks, etc.

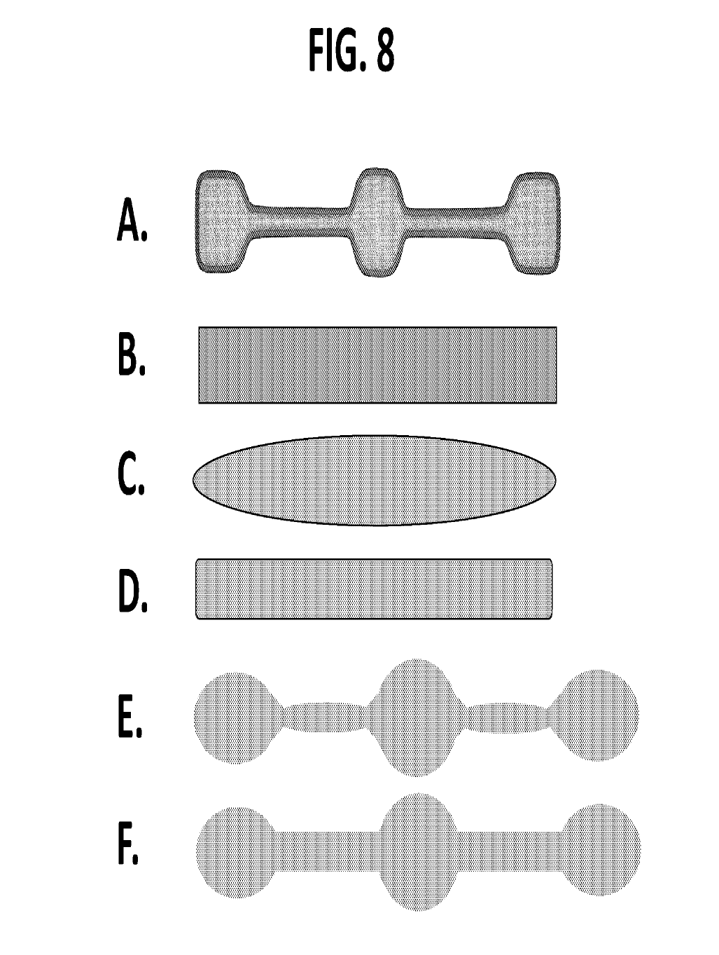

Turning to FIGS. 8A-8F, it is contemplated that the pad-like constructions could be of various size and shapes as shown herein. It is contemplated that one device size can fit a very large range of apparel sizes and styles by having an option to adjust the size as needed, much like a belt. Other options would be to fold the fabric connectors between the heating elements 330, on to itself and attach by means of Velcro® or clips, thus creating a smaller size. Additionally, the fabric connectors 330 may be comprised of an elastic material that serves as a means to adjust device sizing.

Also disclosed herein is a method for heating a piece of clothing apparel worn by a user wherein a heating device as described above is removably attached to the apparel. The heating device may be removably attached using fasteners including, but not limited to: (a) hook and loop fasteners; (b) barb and pile fasteners; (c) buttons; (d) snap fasteners; (e) hook and eye fasteners; (f) zippers; (g) pins; (h) buckle fasteners; (i) strap fasteners; G) slide fasteners; (k) glue; (l) polymer bases adhesive; (m) high tack adhesive; (n) quick setting adhesive or (o) combinations thereof wherein one end of the fastener is permanently or removably attached to the heating device and the corresponding end of the fastener is permanently or removably attached to the apparel.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A heating device for heating a piece of clothing apparel worn by a user comprising:
a. a plurality of integral pad-like constructions, each comprising a plurality of substantially planar fabric layers with a proximal surface and a distal surface with respect to the user;
b. a plurality of electrically conductive wires embedded in or attached to the interior or exterior surface of at least one of the plurality of substantially planar fabric layers;
c. an insulated wire;
d. a compact, light-weight power source;
e. a means for removably attaching the distal surface of the integral pad-like constructions to the apparel; and
f. a means for storing the compact, lightweight power source in or on the apparel; wherein the plurality of integral pad-like constructions are connected in series or parallel by the insulated wire;
wherein the insulated wire is removably attachable to the power source such that the insulated wire conducts electricity to the electrically conductive wires when attached to the power source; and
wherein electricity runs through the electrically conductive wires to produce heat in at least one integral pad-like construction.

30. The heating device of claim 29 wherein the bottom surface of a first fabric layer of the plurality of layers is removably attached to the apparel and the top surface of the first fabric layer is a heat reflective material.

31. The heating device of claim 30 wherein the heat reflective material is selected from the group comprising mylar, foil, reflective heat tape or combinations thereof.

32. The heating device according claim 29 wherein a second fabric layer of the plurality of layers that abuts the first fabric layer is constructed of a flexible, breathable material with a high flash point.

33. The heating device according to claim 29 further comprising a third layer wherein the top surface of the third layer of the plurality of layers abuts the second fabric layer and is lined with a heat conductive material.

34. The heating device according to claim 33 wherein the heat conductive material is selected from the group comprising spacer mesh, polyester, cotton mesh, polymer fabric, flannel, fleece or combinations thereof.

35. The heating device according to any one of claim 29 further comprising a plurality of substantially planar fabric connectors between the integral pad-like constructions wherein the insulated wire is hidden inside or behind the substantially planar fabric connectors.

36. The heating device according to claim 35 further comprising a means to secure the integral pad-like constructions in a circumference around the user.

37. The heating device according to claim 29 wherein the compact, light weight power source is a lithium-ion or lithium polymer battery.

38. The heating device according to claim 37 wherein the battery rating is from about 2200 milliampere per hour to about 5000 milliampere per hour.

39. The heating device according to claim 38 wherein the compact, light-weight power source has variable settings to control the amount of heat produced in the integral pad-like constructions.

40. The heating device according to claim 39 further comprising a device connected through a wireless connection wherein the device controls the variable settings on the compact, light-weight power source.

41. The heating device according to claim 40 wherein the material of the electrically conductive wires are selected from the group comprising carbon fiber, stainless steel, steel alloys, metal alloys, heat conductive material or any combination thereof.

42. The heating device according to claim 4′ wherein the means for removably attaching the integral pad-like constructions to the apparel is selected from the group of fasteners comprising (a) hook and loop fasteners; (b) barb and pile fasteners; (c) buttons; (d) snap fasteners; (e) hook and eye fasteners; (f) zippers; (g) pins; (h) buckle fasteners; (i) strap fasteners; (j) slide fasteners; (k) glue; (l) polymer bases adhesive; (m) high tack adhesive; (n) quick setting adhesive or (o) combinations thereof wherein one end of the fastener is permanently or removably attached to the integral pad-like construction and the corresponding end of the fastener is permanently or removably attached to the apparel.

43. A method for heating a piece of clothing apparel worn by a user wherein a heating device is removably attached to the apparel, the heating device comprising:
a. a plurality of integral pad-like constructions, each comprising a plurality of substantially planar fabric layers with a proximal surface and a distal surface with respect to the user;
b. a plurality of electrically conductive wires embedded in or attached to the interior or exterior surface of at least one of the plurality of substantially planar fabric layers;
c. an insulated wire;
d. a compact, light-weight power source;
e. a means for removably attaching the distal surface of the integral pad-like constructions to the apparel; and
f. a means for storing the compact, lightweight power source in or on the apparel; wherein the plurality of integral pad-like constructions are connected in series or parallel by the insulated wire;
wherein the insulated wire is removably attachable to the power source such that the insulated wire conducts electricity to the electrically conductive wires when attached to the power source; and
wherein electricity runs through the electrically conductive wires to produce heat in at least one integral pad-like construction.

44. The method according to claim 43 wherein the means for removably attaching the integral pad-like constructions to the apparel of the heating device is selected from the group of fasteners comprising (a) hook and loop fasteners; (b) barb and pile fasteners; (c) buttons; (d) snap fasteners; (e) hook and eye fasteners; (f) zippers; (g) pins; (h) buckle fasteners; (i) strap fasteners; (j) slide fasteners; (k) glue; (l) polymer bases adhesive; (m) high tack adhesive; (n) quick setting adhesive or (o) combinations thereof wherein one end of the fastener is permanently or removably attached to the integral pad-like constructions and the corresponding end of the fastener is permanently or removably attached to the apparel.

45. The method according to claim 44 wherein the bottom surface of a first fabric layer of the plurality of layers of the integral pad-like constructions of the heating device is removably attached to the apparel and the top surface of the first fabric layer is a heat reflective material.

46. The method according to claim 45 wherein a second fabric layer of the plurality of layers of the integral pad-like constructions of the heating device that abuts the first fabric layer is constructed of a flexible, breathable material with a high flash point.

47. The method according to claim 46 wherein the top surface of a third layer of the plurality of layers of the integral pad-like constructions of the heating device that abuts the second fabric layer is lined with a heat conductive material.

48. The method according to claim 47 further comprising a plurality of substantially planar fabric connectors between the integral pad-like constructions of the heating device wherein the insulated wire is hidden inside or behind the substantially planar fabric connectors.
